(19) United States
(12) Patent Application Publication
(10) Pub. No.: US 2011/0238966 A1
(43) Pub. Date: Sep. 29, 2011

(54) BRANCH PREDICTION METHOD AND BRANCH PREDICTION CIRCUIT FOR EXECUTING THE SAME

(75) Inventor: Yoshimasa Takebe, Kawasaki (JP)

(73) Assignee: FUJITSU LIMITED, Kawasaki (JP)

(21) Appl. No.: 13/070,983

(22) Filed: Mar. 24, 2011

(30) Foreign Application Priority Data
Mar. 26, 2010 (JP) 2010-073827

(51) Int. Cl. G06F 9/38

(52) U.S. Cl. 712/239; 712/E09.045

(57) ABSTRACT

A branch prediction method executed in a branch prediction circuit executes the branch instruction, the branch prediction method includes: a branch information storing process for storing the information in the first storage unit or the second storage unit; a process for determining on the basis of a branch condition set by the branch instruction and a realized branch whether the branch prediction is realized; a rewriting process for performing a rewrite of the information in one of the first storage unit and the second storage unit in accordance with the determination and the degree of likelihood that a branch indicated by the branch prediction occurs; and a process for performing branch prediction in response to the branch information when the branch instruction is executed in the processor.

### CROSS REFERENCE TO RELATED APPLICATION

This application is based upon and claims the benefit of priority from the prior Japanese Patent Application NO. 2010-073827 filed on Mar. 26, 2010, the entire contents of which are incorporated herein by reference.

### FIELD

The embodiments discussed herein are related to a branch prediction method executed in a pipeline processing processor and a branch prediction circuit for executing the branch prediction method.

### BACKGROUND

In a pipeline processing processor in which an instruction code is executed on the basis of a pipeline processing operation, instruction codes are fetched one after the other and individual stages included in the pipeline processing operation are seamlessly operated, in order to prevent the efficiency of a processing operation for instruction codes from decreasing.

However, in a case in which there is a branch in a program, since an instruction code to be executed next is not determined, a fetch operation is waited, and the efficiency of the pipeline processing operation is reduced, thereby causing the performance degradation of the pipeline processing processor to occur.

In order to prevent the performance degradation, branch prediction is performed, and the pipeline processing processor fetches an instruction code to be executed next on the basis of the branch prediction. Here, when the branch prediction is correct, the fetch operation turns out to be valid, and the advantageous effect of the pipeline processing operation is maintained. However, when the branch prediction is not correct, it turns out that a fetched instruction code is discarded and an instruction code located at a correct branch destination is re-fetched.

Accordingly, if the probability that the branch prediction is not correct is high, a demerit such as the increase of a circuit due to the branch prediction processing operation or the like becomes great. Nonetheless, if the probability that the branch prediction is correct is high, a merit due to the branch prediction processing operation becomes greater than the demerit such as the increase of the circuit.

Accordingly, for example, Japanese Laid-open Patent Publication No. 11-96005 proposes a technique used for improving branch prediction accuracy. According to Japanese Laid-open Patent Publication No. 11-96005, a parallel processor is described that includes a plurality of parallel pipelines, identifies, on the basis of a past history, a conditional branch instruction code the branch prediction of which is difficult, and executes both a branch-side instruction code and a non-branch-side instruction code in a speculative manner. In addition, when it is difficult to execute both the branch-side instruction code and the non-branch-side instruction code in a speculative manner for the conditional branch instruction code, namely, there is no vacancy in the parallel pipelines, the parallel processor predicts whether or not a condition is correct, on the basis of past history information, and selects and executes the branch-side instruction code or the non-branch-side instruction code on the basis of the prediction result.

However, when whether or not the condition is correct is predicted on the basis of past history information, generally speaking, it is requested for the processor to retain a branch target buffer (BTB: branch address buffer) in which a large amount of history information is registered, in order to obtain high prediction accuracy. As a result, when, from the point of view of a cost, it is difficult for the processor to retain the large-sized BTB, the prediction accuracy turns out to be reduced. In addition, depending on a prediction method, since effective information is concentrated in a specific area in the BTB in which the history information is registered, an operation in which history information is replaced is frequently carried out. Therefore, the number of times the BTB is accessed increases, and hence the power consumption of the processor turns out to be increased.

### SUMMARY

According to one aspect of the embodiments, there is provided a branch prediction method executed in a branch prediction circuit included in a processor that includes a first and a second storage units configured to store a branch instruction, branch prediction, and information indicating the degree of likelihood that a branch indicated by the branch prediction occurs, and executes the branch instruction. The branch prediction method includes an information storing process for storing the information in the first storage unit or the second storage unit, a process for determining on the basis of a branch condition set by the branch instruction and a realized branch whether the branch prediction is realized, a rewriting process for performing a rewrite of the information in one of the first storage unit and the second storage unit in accordance with the determination and the degree of likelihood that a branch indicated by the branch prediction occurs, and a process for performing branch prediction in response to the information when the branch instruction is executed in the processor.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating a computer relating to an embodiment;

FIGS. 2A and 2B are diagrams illustrating a pipeline operation performed when an instruction is input to the computer in FIG. 1;

FIG. 3 illustrates a flowchart when new history information and a BTB entry are registered in a branch target buffer (BTB) in which a branch address is stored;

FIG. 4 is a circuit block diagram illustrating a BTB entry management circuit included in a Branch Prediction; and

FIG. 5 is a diagram for explaining a prediction operation performed in the BTB entry management circuit.

### DESCRIPTION OF EMBODIMENTS

The present invention includes an embodiment obtained by adding a design modification those skilled in the art may conceive of to an embodiment described later and an embodiment obtained by recombining configuration elements included in the embodiment described later. In addition, the present invention includes an embodiment obtained by replacing the configuration elements with other configuration elements that have the same function effects, and is not limited to the following embodiment.

### Embodiments

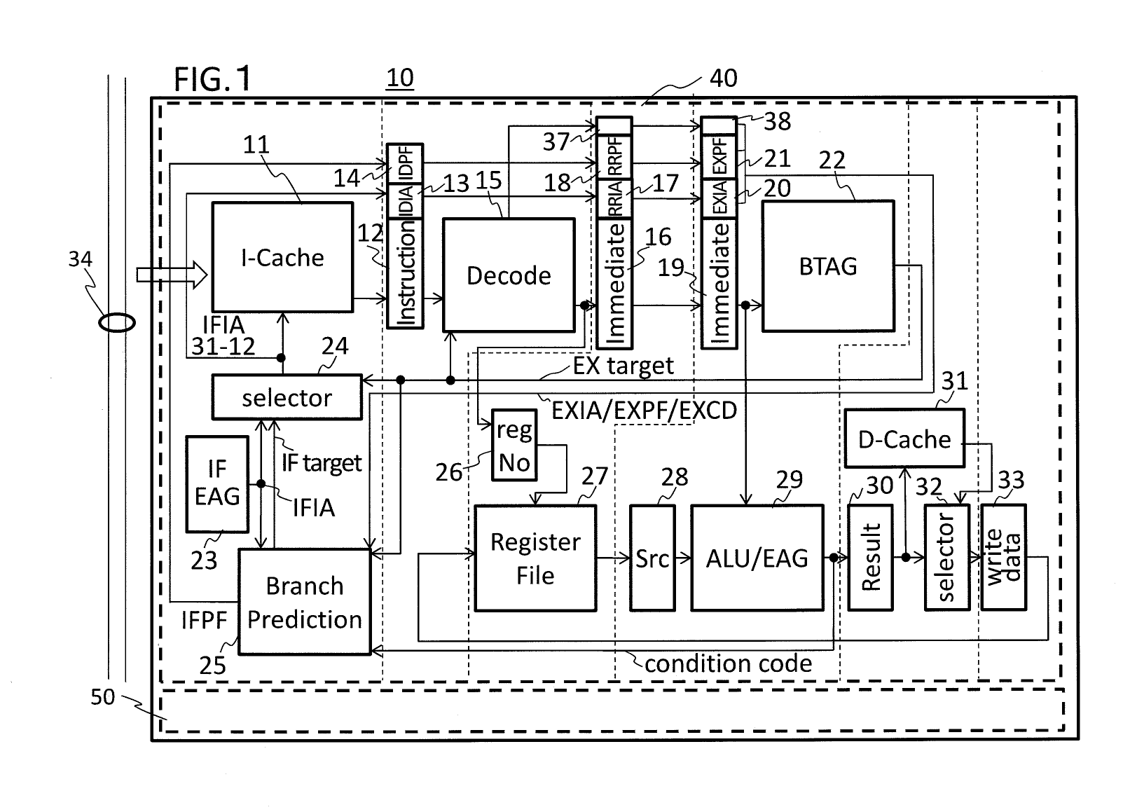

FIG. 1 is a diagram illustrating a computer 10 relating to the embodiment. The computer 10 is a computer that includes pipelines 40 and 50, each of which includes an I-Cache 11, a register 12, a register 13, a register 14, a Decode 15, a register 16, a register 17, a register 18, a register 19, a register 20, a register 21, a BTAG 22, an IFEAG 23, a Selector 24, a Branch Prediction 25, a Reg No 26, a Register File 27, an Src 28, an ALU/EAG 29, a Result 30, a D-Cache 31, a Selector 32, a Write data 33, a RCD register 37, and an EXCD register 38. In addition, as described later, the pipeline includes stages individually corresponding to instruction prefetch (IF), instruction decode (ID), register read (RR), instruction execution (EX), memory access (MA), and write back (WB). In addition, dotted lines illustrated in FIG. 1 illustrate boundary lines between circuits belonging to the individual stages in the pipeline.

In the instruction prefetch stage, the IFEAG 23 is a circuit for calculating an address, Instruction Fetch Instruction Address (IFIA), indicating a storage area in which an instruction to be fetched next is stored. After that, the IFEAG 23 outputs an IFIA to the Selector 24 and the Branch Prediction 25.

The I-Cache 11 is an instruction cache for storing therein an instruction (Instruction) supplied from the outside of the computer 10 through an external bus 34 as indicated by an arrowed line. In addition, in the instruction prefetch (IF) stage in a pipeline processing operation, when the I-Cache 11 receives the IFIA from the Selector 24, the I-Cache 11 reads out a corresponding instruction (Instruction) from a storage area included in the I-Cache 11 and outputs the instruction to the register 12.

In the instruction prefetch stage, when receiving the IFIA from the IFEAG 23, the Branch Prediction 25 is a circuit that predicts a branch direction and a branch destination address for a branch instruction, and includes a branch prediction mechanism. After the branch prediction, the Branch Prediction 25 outputs to the selector 24 an IF target that indicates a branch destination corresponding to the branch prediction, and outputs, to the register 14, an instruction fetch profile (IFPF) as an instruction decode profile (IDPF).

The IFPF is a 2-bit digital count value, and the count value indicates the degree of likelihood that a branch indicated by an IF target corresponding to the branch instruction occurs. For example, a counter value “11” indicates “strongly taken” (high branch likelihood), a counter value “10” indicates “weakly taken” (low branch likelihood), a counter value “01” indicates “weakly not taken” (low non-branch likelihood), and a counter value “00” indicates “strongly not taken” (high non-branch likelihood). The counter value is history information to be updated in accordance with the evaluation of whether or not a branch occurs in response to a branch instruction. For example, when no branch occurs in response to the branch instruction, the counter value corresponding to the branch instruction is decremented (decreased), and the count value shifts in the direction of “weakly not taken” (high non-branch likelihood).

In the instruction prefetch stage, when an instruction is a branch instruction, the Selector 24 selects and outputs the combination of an IF target from the Branch Prediction 25 and an IFIA to the I-Cache 11. In this regard, however, when an EX target output from the BTAG 22 designates a branch destination different from a branch destination indicated by the IF target, the Selector 24 outputs the EX target to the I-Cache 11 again. When an instruction is not a branch instruction, the Selector 24 only outputs the IFIA from the IFEAG 23 to the I-Cache 11.

In addition, the IFIA has bits ranging from zeroth bit to 31th bit, and the Selector 24 outputs to the register 13 the bits of the IFIA ranging from 12th bit to 31th bit as an instruction decode instruction address (IDIA). In addition, the IDIA is used as an address for a storage area included in the branch prediction mechanism in the Branch Prediction 25.

Next, in the instruction decode stage (ID) in the pipeline processing operation, the register 12 is an instruction storage register used for storing an instruction output from the I-Cache 11.

In the instruction decode stage, the register 13 is an address register used for storing the IDIA output from the Selector 24.

In the instruction decode stage, the register 14 is a profile buffer used for storing the profile of an instruction output from the I-Cache 11.

In the instruction decode stage, the Decode 15 decodes an immediate value (immediate) from an instruction, and calculates a resister read branch condition code (RRBCD).

Here, the RRBCD is a code indicating which of a plurality of branch conditions is met. In addition, the branch conditions include a condition that no branch occurs.

In the register read stage (RR) of the pipeline, the register 16 is a register used for storing an “immediate” (immediate value: a value used for identifying a processing target) supplied from the Decode 15. In addition, the Register File 27 is a storage circuit used for receiving the “immediate” from the Reg No 26 and storing the “immediate” therein.

In the register read stage, the register 17 is an address register used for storing a resister read instruction address (RRIA) relating to the “immediate” output from the Decode 15. The IDIA stored in the register 13 is stored as the register read instruction address (RRIA) in the register 17.

In the register read stage, the register 18 is a profile register used for storing, as a register read profile (RRPF), the IDPF output from the register 14.

In the register read stage, the branch condition register 37 is a register used for storing the RRBCD output from the Decode 15.

In the instruction execution stage (EX) of the pipeline, the register 19 is a register used for receiving the “Immediate” stored in the register 16 and storing the “Immediate”.

In the instruction execution stage (EX) of the pipeline, the register 20 is an address register used for receiving the RRIA stored in the register 17 and storing the RRIA as an execute instruction address (EXIA).

In the instruction execution stage (EX) of the pipeline, the register 21 is a profile buffer used for receiving the RRPF stored in the register 18 and storing the RRPF as an execute profile (EXPF). In the instruction execution stage (EX) of the pipeline, the register 38 receives the RRBCD stored in the register 37 and stores the RRBCD as an execute branch condition code (EXBCD).

In the instruction execution stage (EX) of the pipeline, when a predicted branch has not been performed and a branch prediction miss occurs or when branch prediction has not been performed, the BTAG 22 calculates a branch destination address and outputs the branch destination address (EX target) to the Selector 24 and the Branch Prediction 25.

In the instruction execution stage (EX) of the pipeline, the Src 28 is a register used for storing the “immediate” (a value used for identifying a processing target) read out from the Register File 27.

In the instruction execution stage (EX) of the pipeline, the ALU/EAG 29 performs a calculation operation specified by an instruction and an address calculation for data access. Here, examples of the calculation operation include amplitude comparison of values, subtraction, and addition. In addition, the ALU/EAG 29 outputs to the Branch Prediction 25 a condition code (branch condition) relating to a branch instruction.

In the memory access stage (MA), the Result 30 is a register used for storing the results of the calculation operation and the address calculation for data access, which are performed in the ALU/EAG 29.

In the memory access stage (MA), the D-Cache 31 is a cache used for temporarily storing therein the result of the calculation operation and the result of the address calculation for data access, which are supplied from the Result 30, and, after that, outputting to the Selector 32 the result of the calculation operation and the result of the address calculation.

In the memory access stage (MA), the Selector 32 is a circuit used for selecting the result of the calculation operation and the result of the address calculation, supplied from the Result 30, or the result of the calculation operation and the result of the address calculation, stored in the D-Cache 31, and outputting to the Write data 33 the selected result of the calculation operation and the selected result of the address calculation.

In the write back stage (WB), the Write data 33 is a register used for storing data to be stored in the Register File 27.

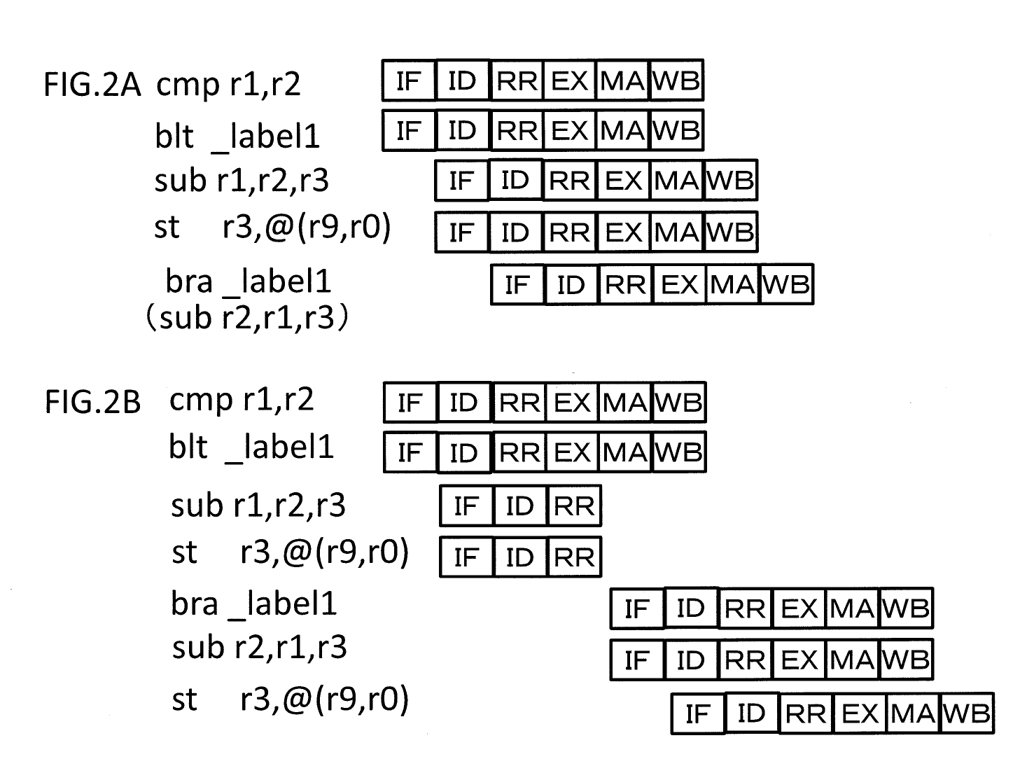

FIGS. 2A and 2B are diagrams illustrating a pipeline operation performed when an instruction is input to the computer 10 in FIG. 1. In addition, the pipeline includes stages individually corresponding to instruction prefetch (IF), instruction decode (ID), register read (RR), instruction execution (EX), memory access (MA), and write back (WB).

FIG. 2A illustrates the operation of the pipeline when branch prediction matches an actual branch. FIG. 2A illustrates an example of a case in which branch prediction has been correct in the pipeline operation when an instruction cmp r1, r2, an instruction blt_label 1, an instruction sub r1, r2, r3, (an instruction bra_label 1), (an instruction sub r1, r2, r3), and an instruction st r3, @(r9, r0) are executed. The gist of the above-mentioned instructions is as follows. First, a numerical value r1 is compared with a numerical value r2. Next, when the r1 is greater, a calculation r3=r1−r2 is performed, and when the r2 is greater, a calculation r3=r2−r1 is performed. Next, the result r3 is stored in a register designated by a numerical value r9 and a numerical value r0.

Therefore, in the computer 10 illustrated in FIG. 1, the above-mentioned instructions are processed in parallel in units of two instructions in the pipelines 40 and 50. First, the instruction cmp r1, r2 and the instruction blt_label 1 are set in the instruction fetch stage. Next, in response to a branch address output from the Branch Prediction 25 including the branch prediction mechanism in each of the pipelines 40 and 50, the instruction sub r1, r2, r3 and the instruction st r3, @(r9, r0) are set in the instruction fetch stage. Here, when the instruction cmp r1, r2 and the instruction blt_label 1, set first in the instruction fetch stage, come into the instruction execution stage, the results thereof are fixed, and the branch prediction is correct, the instruction sub r1, r2, r3 and the instruction st r3, @(r9, r0), set next in the instruction fetch stage, are continue to be executed. In addition, an operation result from the ALU/EAG 29 in the pipeline 50 is transmitted to the Branch Prediction 25 in each of the pipelines 40 and 50. As a result, in the Branch Prediction 25 in each of the pipelines 40 and 50, the profile (history information) of a branch address is updated with respect to concordance between the branch prediction and the actual branch.

FIG. 2B illustrates the operation of the pipeline performed when branch prediction does not match an actual branch. FIG. 2B illustrates an example of a case in which branch prediction has been correct in the pipeline operation when an instruction cmp r1, r2, an instruction blt_label 1, an instruction sub r1, r2, r3, an instruction bra_label 1, an instruction sub r1, r2, r3, and an instruction st r3, @(r9, r0) are executed. The gist of the above-mentioned instructions is as follows. First, a numerical value r1 is compared with a numerical value r2. Next, when the r1 is greater, a calculation r3=r1−r2 is performed, and when the r2 is greater, a calculation r3=r2−r1 is performed. Next, the result r3 is stored in a register designated by a numerical value r9 and a numerical value r0.

Therefore, in the computer 10 illustrated in FIG. 1, first, in the pipelines 40 and 50, the instruction cmp r1, r2 and the instruction blt_label 1 are set in the instruction fetch stage.

Next, in the same way, in response to a branch address output from the Branch Prediction 25 including the branch prediction mechanism in each of the pipelines 40 and 50, the instruction sub r1, r2, r3 and the instruction st r3, @(r9, r0) are set in the instruction fetch stage. Here, when the results of the instruction cmp r1, r2 and the instruction blt_label 1, set in the instruction execution stage, are fixed and the branch prediction is not correct, the pipeline operation for the instruction sub r1, r2, r3 and the instruction st r3, @(r9, r0) is halted. In addition, the instruction bra_label 1 and the instruction sub r1, r2, r3, which correspond to a correct branch destination, are executed. When the pipeline operation for the instruction sub r1, r2, r3 and the instruction st r3, @(r9, r0) is halted, an operation result from the ALU/EAG 29 in the pipeline 50 is transmitted to the Branch Prediction 25 in each of the pipelines 40 and 50. As a result, in the Branch Prediction 25 in each of the pipelines 40 and 50, the profile (history information) of a branch address is updated with respect to discordance between the branch prediction and the actual branch.

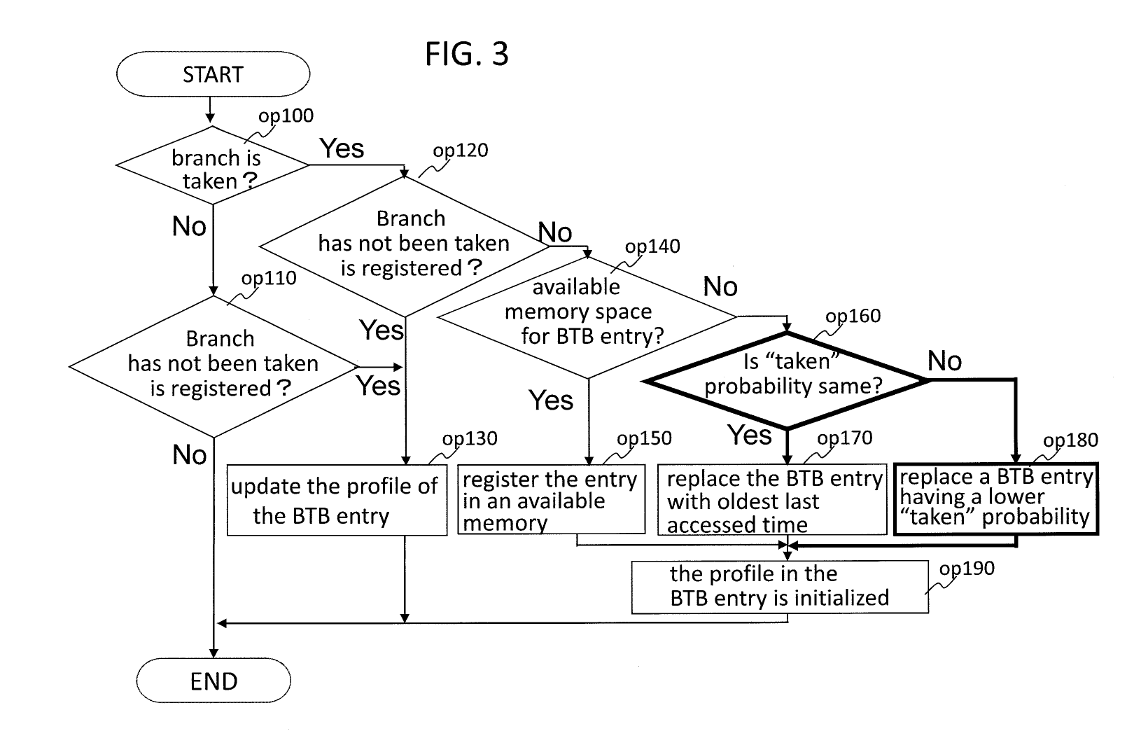

FIG. 3 illustrates a flowchart when new history information and a BTB entry are registered in the branch target buffer (BTB) in which a branch address is stored.

Here, the BTB entry management circuit 200 used for storing the BTB entry is included in the Branch Prediction 25 in which the branch prediction mechanism is included. In addition, the BTB entry includes a storage address for a branch instruction (instruction), an address (target) indicating a branch destination, a profile (PF: history information) indicating the degree of likelihood that the branch occurs, and a VFLAG (valid flag) indicating that the BTB entry is fixed.

In the computer 10, when the EX target indicating an actual branch condition is output from the BTAG 22 to the Branch Prediction 25, determination in Operation op100 in the flowchart illustrated in FIG. 3 is performed.

In Operation op100, the Branch Prediction 25 determines whether or not a branch based on prediction has been performed, namely, a branch corresponding to a BTB entry on the basis of which the prediction has been performed has been put into a “taken” state. When the branch has been performed (the branch has been put into a “taken” state), the processing operation proceeds to Operation op120. On the other hand, when the branch has not been performed (the branch has been put into a “not taken” state), the operation proceeds to Operation op110.

In Operation op110, the Branch Prediction 25 determines whether or not a BTB entry including a branch address into which the branch has not been performed is registered in the BTB in the BTB entry management circuit 200. When the BTB entry is not registered in the BTB in the BTB entry management circuit 200, the Branch Prediction 25 terminates the operation with making no modification to all BTB entries stored in the BTB entry management circuit 200.

In Operation op120, the Branch Prediction 25 determines whether or not the BTB entry including a branch address into which the branch has been performed is registered in the BTB in the BTB entry management circuit 200. When the BTB entry including a branch address into which the branch has been performed is registered in the BTB, the operation proceeds to Operation op130. When the BTB entry including a branch address into which the branch has been performed is not registered in the BTB, the operation proceeds to Operation op140.

In Operation op130, the Branch Prediction 25 updates the profile (history information) of the BTB entry including a branch address into which the branch has been performed.

In Operation op140, the Branch Prediction 25 determines whether or not there is a vacancy in the storage area of the BTB in the BTB entry management circuit 200, in which the BTB entry including a branch address into which the branch has been performed is registered. When there is a vacancy in the storage area of the BTB in the BTB entry management circuit 200, the operation proceeds to Operation op150. When there is no vacancy in the storage area of the BTB in the BTB entry management circuit 200, the operation proceeds to Operation op160.

In Operation op150, the BTB entry including a branch address into which the branch has been performed is written into the vacant storage area of the BTB in the BTB entry management circuit 200. After that, the operation proceeds to Operation op190.

In Operation op160, when there is no vacancy in the storage area of the BTB, the Branch Prediction 25 detects a BTB entry where the storage address of a branch instruction (instruction) matches the EXIA. Since a BTB 240 and a BTB 250 are provided as the BTBs in the BTB entry management circuit 200, one BTB entry from the BTB 240 and one BTB entry from the BTB 250, two BTB entries in total, are detected as the BTB entry where the storage address of a branch instruction (instruction) matches the EXIA.

In addition, the Branch Prediction 25 compares the profiles (history information, namely, “taken” probabilities) of the detected BTB entries with each other.

As a result, when the counter values of the detected BTB entries are the same, the Branch Prediction 25 proceeds to Operation op170. In addition, the counter value of one of the detected BTB entries is lower, the operation proceeds to Operation op180.

Here, if a BTB entry is replaced depending on whether or not a last time when the BTB entry was referred to is older, without determining whether the counter value is higher or lower, namely, whether or not a “taken” probability is lower, the BTB entry turns out to be replaced even if the “taken” probability of a branch is critically high. Namely, since a BTB entry having the lower “taken” probability of a branch remains in the BTB, the accuracy of the branch prediction of the prediction mechanism is reduced. Therefore, it may be considered that the number of stored BTB entries is increased in order to reduce the number of times the BTB entry is replaced.

In that case, since the BTB entry includes 53 bits in total: 20 bits indicating the storage address of a branch instruction (instruction), 30 bits indicating an address (target) that indicates a branch destination, 2 bits indicating a profile, and 1 bit indicating validity, the storage area of the BTB increases, and hence the area of circuits included in the prediction mechanism included in the Branch Prediction 25 increases.

Accordingly, if, by comparing the profiles of the detected BTB entries with the profile of a detected BTB entry input to the Branch Prediction 25, it is determined whether or not a “taken” probability is lower, and a BTB entry having a lower “taken” probability from among the detected BTB entries is replaced with the combination of the EX target, the EXIA, and the EXPF, the prediction probability of the prediction mechanism turns out to be increased without increasing the number of BTB entries to be stored, namely, increasing the circuit area of the prediction mechanism.

In addition, while, in the above description, with respect to two BTB entries, it is determined whether or not the “taken” probabilities thereof are lower, the BTB entries may be selected in order with no priority thereon, regardless of the “taken” probabilities of the BTB entries. Furthermore, one BTB entry to be a replace target may be randomly selected. Furthermore, using a late recently used (LRU) management circuit described later, a BTB entry where a last time when the BTB entry was referred to is older may be selected as a target from among BTB entries having lower counter values.

In Operation op170, the Branch Prediction 25 detects a BTB entry where a last time when the LRU management circuit referred to the BTB entry is older, from among already registered BTB entries where the storage addresses of branch instructions (instruction) are matched. Therefore, the BTB entry where a last time when the BTB entry was referred to is older is replaced with the combination of the EX target, the EXIA, and the EXPF, which are to be newly registered. After that, the operation proceeds to Operation op190.

In addition, while, in the above description, it is detected, on the basis of a time when a BTB entry was referred to, whether the BTB entry is old one or new one, it may be detected, using order information set on the basis of a time when a BTB entry was referred to, whether the BTB entry is old one or new one.

In Operation op180, from among already registered BTB entries where the storage addresses of branch instructions (instruction) are matched, the Branch Prediction 25 replaces a BTB entry having a lower “taken” probability (a counter value for a profile is lower) with the combination of the EX target, the EXIA, and the EXPF. After that, the operation proceeds to Operation op190.

In Operation op190, a profile (history information) in the BTB entry subjected to the replacement is initialized. The initialization corresponds to setting the counter value of a profile to a predetermined value, and the counter value is set to “11” (“strongly taken” (high branch likelihood)), for example.

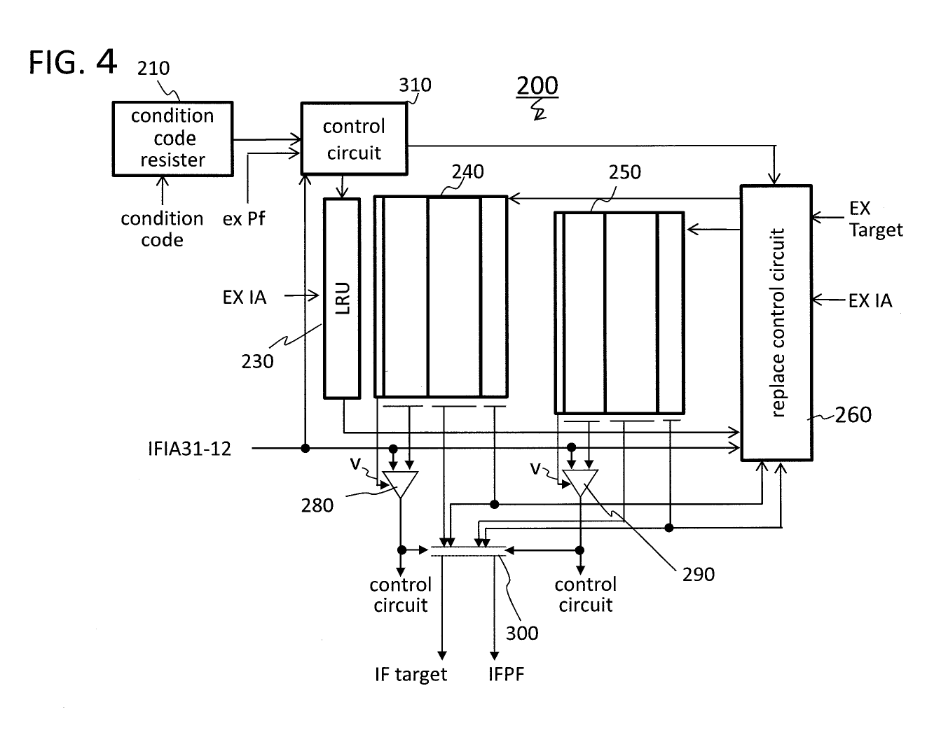

FIG. 4 is a circuit block diagram illustrating the BTB entry management circuit 200 included in the Branch Prediction 25.

The BTB entry management circuit 200 includes a condition-code-resister 210, an LRU management circuit 230, BTBs 240 and 250, a replace control circuit 260, matching detection circuits 280 and 290, a multiplexer 300, and a control circuit 310.

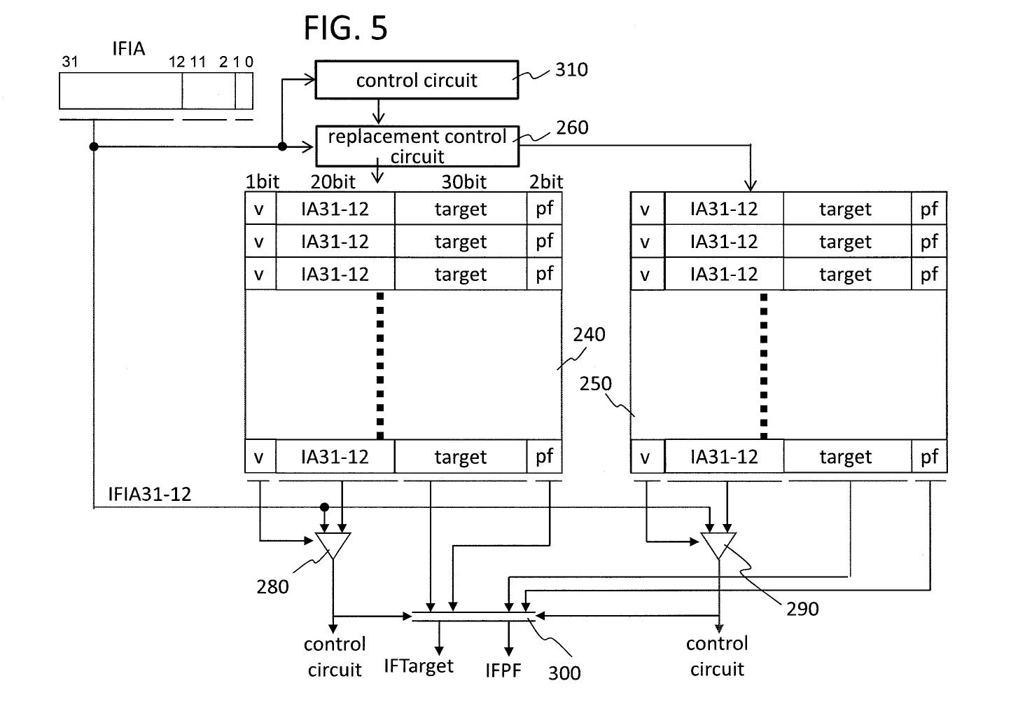

In the instruction prefetch stage, the BTB entry management circuit 200 performs the prediction of a branch destination address on a fetched instruction indicating a branch condition. The detail thereof will be described with reference to FIG. 5.

In the instruction execution stage (EX) of the pipeline, on the basis of the branch prediction result, the BTB entry management circuit 200 determines whether the update of the history information of the BTB entry, the replacement of the BTB entry, or the update or the replacement of BTB entry is performed.

The condition-code-resister 210 is a register used for storing a branch condition for a branch instruction. In addition, the condition-code-resister 210 outputs the branch condition to the control circuit 310.

When the branch instruction is executed, the control circuit 310 performs the determination operation described with reference to FIG. 4. In addition, in order to determine whether BTB entries are registered in the BTBs 240 and 250, it is requested to replace an already registered BTB entry with a BTB entry relating to a currently executed branch instruction, or it is requested to update the profile (history information) of an already registered BTB entry, the control circuit 310 outputs activation signals to the replace control circuit 260 and the LRU management circuit 230.

First, the control circuit 310 receives the branch condition from the condition-code-resister 210, and determinates, on the basis of the EXBCD received from the BTAG 22, whether or not a branch has been put into a “taken” state. Furthermore, the control circuit 310 determinates, on the basis of a matching signal from the matching detection circuit 280, whether or not a BTB entry has been registered in the BTB 240 or the BTB 250, the BTB entry relating to the combination of a branch instruction where a branch has not been put into a “taken” state and the branch prediction thereof, and furthermore determinates whether or not a BTB entry has been registered in the BTB 240 or the BTB 250, the BTB entry relating to the combination of a branch instruction where a branch has been put into a “taken” state and the branch prediction thereof.

As a result, when a branch has not been put into a “taken” state, and furthermore the BTB entry relating to the combination of the branch instruction and the branch prediction thereof has been registered in the BTB 240 or the BTB 250, the control circuit 310 sends the activation signal to the replace control circuit 260, accesses the BTB 240 or the BTB 250 using the EXIA as an address, and rewrites the PF (profile: history information) of a BTB entry registered in a storage area designated by the address, so as to decrement the count value of the history information.

On the other hand, when a branch has been put into a “taken” state, and furthermore the BTB entry relating to the combination of the branch instruction and the branch prediction thereof has been registered in the BTB 240 or the BTB 250, the control circuit 310 sends the activation signal to the replace control circuit 260, and rewrites the PF (profile: history information) of the BTB entry registered in the BTB 240 or the BTB 250, so as to increment the count value of the history information. Namely, after incrementing the count value of the EXPF by one, the control circuit 310 sends the EXPF to the replace control circuit 260, and the replace control circuit 260 replaces the PF of the BTB entry with the EXPF.

Incidentally, when a branch has been put into a “taken” state, and furthermore it is determined, on the basis of the matching signal from the matching detection circuit 280, that the BTB entry relating to the combination of the branch instruction and the branch prediction thereof has not been registered in the BTB 240 or the BTB 250, the control circuit 310 accesses the BTB 240 or the BTB 250 using the EXIA as an address, and determines whether or not there is an empty area in the BTB 240 or the BTB 250.

When there is an empty area in the BTB 240 or the BTB 250, using the EXIA as an address, the control circuit 310 controls the replace control circuit 260 so that the BTB entry relating to the combination of the branch instruction where a branch has been put into a “taken” state and the branch prediction thereof is registered in the empty area.

When there is no empty area in the BTB 240 or the BTB 250, the control circuit 310 detects a BTB entry registered in a storage area in the BTB 240 and a BTB entry registered in an area in the BTB 250, the areas being indicated by the EXIA. The above-mentioned replace control circuit 260 receives the PFs (profile: history information) of the detected BTB entries, and determines which of the counter values of two BTB entries is smaller, namely, which of the “taken” probabilities of two BTB entries is smaller, or whether the counter values are the same. In addition, the replace control circuit 260 replaces the BTB entry whose counter value is smaller with the combination of the EXIA, the EX target, and the EXPF, which are input.

On the other hand, when it is determined that the counter values are the same, the control circuit 310 outputs a signal used for activating the LRU management circuit 230. The LRU management circuit 230 transmits to the replace control circuit 260 the registration time of a BTB entry registered in a storage area in the BTB 240 and the registration time of a BTB entry registered in an area in the BTB 250, the areas being indicated by the EXIA. On the basis of the registration times of the BTB entries, the replace control circuit 260 identifies a BTB entry having an older registration time from among the above-mentioned two BTB entries. The replace control circuit 260 replaces the BTB entry having an older registration time with the BTB entry relating to the combination of a branch instruction where a branch has been put into a “taken” state and the branch prediction thereof (the combination of the EXIA, the EX target, and the EXPF, which are input).

Incidentally, while, in the above description, a BTB entry to be replaced is selected depending on whether a registration time in the LRU management circuit 230 is new or old, a BTB entry to be replaced may be selected using a round-robin algorithm in which a BTB entry stored in the BTB 240 and a BTB entry stored in the BTB 250 are alternately selected. Furthermore, using a random algorithm, a BTB entry to be replaced may be selected from among a BTB entry stored in the BTB 240 and a BTB entry stored in the BTB 250.

In addition, in the above description, when the BTB entry is registered in the BTB 240 or the BTB 250, the BTB entry relating to the combination of a branch instruction where a branch has been put into a “taken” state and the branch prediction thereof, or the BTB entry having the older registration time is replaced, the replace control circuit 260 sets the PF (history information) of a new BTB entry to an initial value. For example, it may be considered that the initial value is set to a count value “11” corresponding to “strongly taken” (high branch likelihood).

In addition, when the replacement of a BTB entry with a new BTB entry is performed in the BTB 240 or the BTB 250, the LRU management circuit 230 records the registration time thereof. In this regard, however, the embodiment is not limited to the recording of the registration time itself but registration order information corresponding to the registration time may be recorded.

Incidentally, while, in FIG. 4, the BTB entry management circuit 200 includes the BTBs 240 and 250 as circuits for storing the BTB entries, the number of the circuits for storing the BTB entries is not limited to two but the number of the circuits may be more than two. When there are more than two circuits for storing the BTB entries, all the circuits for storing the BTB entries are simultaneously accessed using the EXIAs as addresses, and BTB entries the number of which corresponds to the number of the circuits for storing the BTB entries are acquired. In the above case, with respect to which of the plural BTB entries is determined to be replaced, it is natural that a BTB entry to be replaced is determined depending on whether the “taken” probability thereof is large or small, namely, the counter value thereof is large or small.

FIG. 5 is a diagram for explaining a prediction operation performed in the BTB entry management circuit 20. In addition, FIG. 5 is a circuit block diagram obtained by extracting a circuit block for performing the prediction operation from the circuit block diagram illustrated in FIG. 4.

In the instruction prefetch stage, the BTB entry management circuit 200 performs the prediction of a branch destination address on a fetched instruction indicating a branch condition.

The BTBs 240 and 250 are circuits that store therein BTB entries and read out the BTB entries in accordance with addresses from the replace control circuit 260.

When receiving the IFIA, the control circuit 310 transmits the activation signal to the replace control circuit 260. The replace control circuit 260 uses the bits of the IFIA ranging from 12th bit to 31th bit as an address, and reads out BTB entries from an area in the BTB 240 and an area in the BTB 250, the areas being designated by the address. Here, the BTB entry includes 53 bits: 2 bits corresponding to the IFPF, 30 bits corresponding to the IF target, 20 bits corresponding to the bits of the IFIA ranging from 12th bit to 31th bit, and 1 bit corresponding to the VFLAG. Accordingly, if the number of BTB entries is increased in order to improve the accuracy of the branch prediction, an area occupied by the BTBs 240 and 250 increases.

The matching detection circuits 280 and 290 are circuits that compare IAs 31-12 output from the BTBs 240 and 250 with the bits of the input IFIA ranging from 12th bit to 31th bit and individually output matching signals to the multiplexer 300 and the control circuit 310. In this regard, however, the matching signal is output only when the logic of the VFLAG of the BTB entry is “1”.

The multiplexer 300 receives the matching signal, the IF target, and the IFPF, output from each of the BTBs 240 and 250, and outputs the IF target corresponding to one of the IFPFs output from the BTBs 240 and 250, the counter value of which is larger, and the IFPF. In addition, the IF target is output to the Selector 24, and the IFPF is output to the register 14.

Incidentally, while, in FIG. 5, the BTB entry management circuit 200 includes the BTBs 240 and 250 as circuits for storing the BTB entries, the number of the circuits for storing the BTB entries is not limited to two but the number of the circuits may be more than two. When there are more than two circuits for storing the BTB entries, all the circuits for storing the BTB entries are simultaneously accessed using the EXIAs as addresses, and BTB entries the number of which corresponds to the number of the circuits for storing the BTB entries are acquired. Also in the above case, with respect to which of the plural BTB entries is determined to be replaced, it is natural that a BTB entry to be replaced is determined depending on whether the “taken” probability thereof is large or small, namely, the counter value thereof is large or small.

Accordingly, a branch prediction circuit (the BTB entry management circuit 200) includes a first storage unit (the BTB 240) and a second storage unit (the BTB 250) configured to store information including a branch instruction, branch prediction, and the degree of likelihood that a branch indicated by the branch prediction occurs, a control circuit (the control circuit 310) that determines on the basis of a branch condition (a condition code stored in the condition-code-resister 210) set by the branch instruction and a realized branch (EXBCD) whether or not the branch prediction is realized and controls the rewrite of the information in one of the first storage unit and the second storage unit in accordance with the determination and the degree of likelihood that a branch indicated by the branch prediction occurs, and a rewriting circuit that rewrites the information in one of the first storage unit and the second storage unit in response to the control performed by the control circuit (the control circuit 310).

Furthermore, when the branch prediction is brought to realization or is not brought to realization, the degree of likelihood that a branch indicated by the branch prediction occurs is updated.

A branch prediction method executed in a processor (the computer 10), which includes a branch prediction circuit (the BTB entry management circuit 200) including a first unit (the BTB 240) and a second storage unit (the BTB 250) configured to store information including a branch instruction, branch prediction, and the degree of likelihood that a branch indicated by the branch prediction occurs, and executes the branch instruction, the branch prediction method including an information storing process for storing the information in the first storage unit or the second storage unit, a process for determining on the basis of a branch condition (a condition code stored in the condition-code-resister 210) set by the branch instruction and a realized branch (EXBCD) whether the branch prediction is realized, a rewriting process for performing a rewrite of the information in one of the first storage unit and the second storage unit in accordance with the determination and the degree of likelihood that a branch indicated by the branch prediction occurs, and a process for performing branch prediction in response to the information when the branch instruction is executed in the processor.

Furthermore, the branch prediction method includes a process for storing storage order with respect to the information in the first storage unit and the information in the second storage unit, wherein, in the rewriting process, when the degrees of likelihood that branches indicated by the branch prediction occur are the same with respect to the information in the first storage unit and the information in the second storage unit, the information in one of the first storage unit and the second storage unit is rewritten in accordance with the storage order.

Furthermore, in the branch prediction method, in the rewriting process, when the degrees of likelihood that branches indicated by the branch prediction occur are the same with respect to the information in the first storage unit and the information in the second storage unit, one of the information stored in the first storage unit and the information stored in the second storage unit is sequentially selected and rewritten.

Furthermore, in the branch prediction method, in the rewriting process, when the degrees of likelihood that branches indicated by the branch prediction occur are the same with respect to the information in the first storage unit and the information in the second storage unit, one of the information stored in the first storage unit and the information stored in the second storage unit is randomly selected and rewritten.

If a BTB entry is replaced depending on whether or not a last time when the BTB entry was referred to is older, without determining whether or not a “taken” probability is lower, the BTB entry turns out to be replaced even if the “taken” probability of a branch is critically high. Namely, since a BTB entry having the lower “taken” probability of a branch remains in the BTB, the accuracy of the branch prediction of the prediction mechanism is reduced.

However, as described above, if a BTB entry having the higher “taken” probability of a branch is caused to remain, an advantageous effect of increasing the probability that information effective for improving the accuracy of the branch prediction from among past history information managed in the BTB entry management circuit 200 remains in the BTB is obtained.

Furthermore, it may be considered that the number of stored BTB entries is increased in order to reduce the number of times the BTB entry is replaced. In that case, since the BTB entry includes 53 bits in total: 20 bits indicating an instruction address, 30 bits indicating a target address, 2 bits indicating a profile, and 1 bit indicating validity, the storage area of the BTB increases, and hence the area of circuits included in the prediction mechanism included in the Branch Prediction 25 increases.

Accordingly, if, with respect to an already registered BTB entry and a BTB entry to be newly registered, it is determined whether or not the “taken” probabilities thereof are lower, and hence a BTB entry having a lower “taken” probability is replaced, the prediction probability of the prediction mechanism turns out to be increased without increasing the number of BTB entries to be stored, namely, increasing the circuit area of the prediction mechanism.

There are provided a branch prediction method and a branch prediction circuit for executing the branch prediction method, in which the probability that information effective for improving the accuracy of branch prediction remains in the branch prediction circuit is increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A branch prediction method executed in a branch prediction circuit included in a processor that includes a first and a second storage units configured to store branch information including a branch instruction, branch prediction, and the degree of likelihood that a branch indicated by the branch prediction occurs, the processor executing the branch instruction, the branch prediction method comprising:
storing process for storing the information in the first storage unit or the second storage unit;
determining on the basis of a branch condition set by the branch instruction and a realized branch whether the branch prediction is realized;
performing a rewrite of the information in one of the first storage unit and the second storage unit in accordance with the determination and the degree of likelihood that a branch indicated by the branch prediction occurs; and
performing branch prediction in response to the branch information when the branch instruction is executed in the processor.

2. The branch prediction method according to claim 1, further comprising:
a process for storing storage order with respect to the branch information in the first storage unit and the branch information in the second storage unit, wherein,
in the performing a rewrite of the information in one of the first storage unit and the second storage unit in accordance with the determination and the degree of likelihood that a branch indicated by the branch prediction occurs,
when the degrees of likelihood that branches indicated by the branch prediction occur are the same with respect to the branch information in the first storage unit and the branch information in the second storage unit, the branch information in one of the first storage unit and the second storage unit is rewritten in accordance with the storage order.

3. The branch prediction method according to claim 1, wherein,
in the performing a rewrite of the information in one of the first storage unit and the second storage unit in accordance with the determination and the degree of likelihood that a branch indicated by the branch prediction occurs,
when the degrees of likelihood that branches indicated by the branch prediction occur are the same with respect to the branch information stored in the first storage unit and the branch information stored in the second storage unit, one of the branch information stored in the first storage unit and the branch information stored in the second storage unit is sequentially selected and rewritten.

4. The branch prediction method according to claim 1, wherein,
in the performing a rewrite of the information in one of the first storage unit and the second storage unit in accordance with the determination and the degree of likelihood that a branch indicated by the branch prediction occurs,
when the degrees of likelihood that branches indicated by the branch prediction occur are the same with respect to the branch information stored in the first storage unit and the branch information stored in the second storage unit, one of the branch information stored in the first storage unit and the branch information stored in the second storage unit is randomly selected and rewritten.

5. A branch prediction circuit comprising:
a first storage unit and a second storage unit that store branch information including a branch instruction, branch prediction, and the degree of likelihood that a branch indicated by the branch prediction occurs;
a control circuit that determines on the basis of a branch condition set by the branch instruction and a realized branch whether or not the branch prediction is realized and controls the rewrite of the branch information in one of the first storage unit and the second storage unit in accordance with the determination and the degree of likelihood that a branch indicated by the branch prediction occurs; and
a rewriting circuit that rewrites the branch information in one of the first storage unit and the second storage unit in response to the control performed by the control circuit.

6. The branch prediction circuit according to claim 5, wherein
when the branch prediction is brought to realization or is not brought to realization, the degree of likelihood that a branch indicated by the branch prediction occurs is updated.

7. A branch prediction circuit comprising:
a plurality of storage units that store branch information including a branch instruction, branch prediction, and the degree of likelihood that a branch indicated by the branch prediction occurs;
a control circuit that determines on the basis of a branch condition set by the branch instruction and a realized branch whether or not the branch prediction is realized and controls the rewrite of the branch information in one of the plural storage units in accordance with the determination and the degree of likelihood that a branch indicated by the branch prediction occurs; and
a rewriting circuit that rewrites the branch information in one of the plural storage units in response to the control performed by the control circuit.
